(19) United States
(12) Patent Application Publication
(10) Pub. No.: US 2009/0063690 A1
(43) Pub. Date: Mar. 5, 2009

(54) CONTINUING AN APPLICATION SESSION USING A DIFFERENT DEVICE FROM ONE THAT ORIGINALLY INITIATED THE APPLICATION SESSION WHILE PRESERVING SESSION WHILE PRESERVING SESSION STATE AND DATA

(75) Inventors: WILLIAM G. VERTHEIN, ARLINGTON HEIGHTS, IL (US); YOGESH BHATT, SCHAUMBURG, IL (US)

Correspondence Address: PATENTS ON DEMAND, P.A.-Motorola, 4581 WESTON ROAD, SUITE 345, WESTON, FL, 33331, US

(73) Assignee: MOTOROLA, INC., SCHAUMBURG, IL (US)

(21) Appl. No.: 11/850,598

(22) Filed: Sep. 5, 2007

(51) Int. Cl. G06F 15/16

(52) U.S. Cl. 709/228

(57) ABSTRACT

The present invention discloses a solution for migrating an application session from one device to another. In the solution, a migration event can be detected during an application session involving an application server and an original device. Client-side session information and server-side session information can be stored. The client-side session information can be conveyed to a transfer device, which establishes a communication connection with the application server. This session can occur after an arbitrary delay from an occurrence of the migration event. Transfer device settings can be changed in accordance with the client-side session information and application server settings can be changed in accordance with the stored server-side information. An application session involving the transfer device and the application server can be conducted, beginning in a state approximately equivalent to that which existed at the time of the migration event.

### BACKGROUND

1. Field of the Invention

The present invention relates to application sessions and, more particularly, to continuing an application session using a different device from one that originally initiated the application session while preserving session state and data.

2. Description of the Related Art

Currently, many communicators use multiple devices to access the same internet-based services. Such internet-based services can include, but are not limited to, Web browsing services, remote application usage, email, text-exchange communications, and the like. In some situations, a communicator may be interrupted while using an internet-based service and may be unable to finish their session. In such a situation, the communicator may want to continue the session on another device that is capable of using the internet-related service. Currently there is no technique for maintaining application session information when changing from one client device to another. To finish an application session started on an original device, a communicator must initiate a new session using a replacement device and repeat steps conducted during the original application session to eventually get to the application state that existed, when the session involving the original device ended.

For example, communicators sometimes frequent internet cafés or cybercafés, which are places where a communicator can use a computer with internet access for a fee, usually per hour or per minute. Internet cafés have become a cultural trend in some countries (e.g., India) where a significant number of internet users in those countries use internet cafés. When a paid time period expires at an internet café, a current session is terminated. It would be beneficial, yet not currently possible, for the interrupted user to continue the terminated application session from a different computing device at an approximately equivalent session state as that that existed when the original session terminated.

### SUMMARY OF THE INVENTION

The present invention can be implemented in accordance with numerous aspects consistent with the material presented herein. For example, one aspect of the present invention can include a method for migrating an application session from one device to another. In the method, a migration event can be detected during an application session involving an application server and an original device. Client-side session information and server-side session information can be stored. The client-side session information can be conveyed to a transfer device, which establishes a communication connection with the application server. This session can occur after an arbitrary delay from an occurrence of the migration event. Transfer device settings can be changed in accordance with the client-side session information and application server settings can be changed in accordance with the stored server-side information. An application session involving the transfer device and the application server can be conducted, beginning in a state approximately equivalent to that which existed at the time of the migration event.

Another aspect of the present invention can include Still another aspect of the present invention can include a communication device that includes a client-side application and a transceiver. The client-side application can be used for conducting an application session involving an application server. The transceiver can connect the communication device to a network. The network can communicatively link the communication device to the application server. The client-side application can begin an application session with the application server in a state in which an application session between an original device and the application server ended.

Still another aspect of the present invention can include an application server configured to execute at least one application during an application session involving a remotely located original device. The application server can include a migration engine configured to handle migration requests. A migration request can be a user initiated request to end the application session involving the original device and after an arbitrary delay initiate a transfer session handled by the application server. The transfer session, which can involve a transfer device, can begin in a state at which the application session involving the original device ends.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a flow chart of a method for continuing a previous application session from a device other than an original device used during the application session.

FIG. 2 is a schematic diagram of a system that is capable of continuing previous application sessions in a state at which the session ended.

FIG. 3 is flow diagram showing a continuation of an application session on a device other than an original device.

FIG. 4 is flow diagram showing a migration of an application session from one device to another without terminating the session.

### DETAILED DESCRIPTION OF THE INVENTION

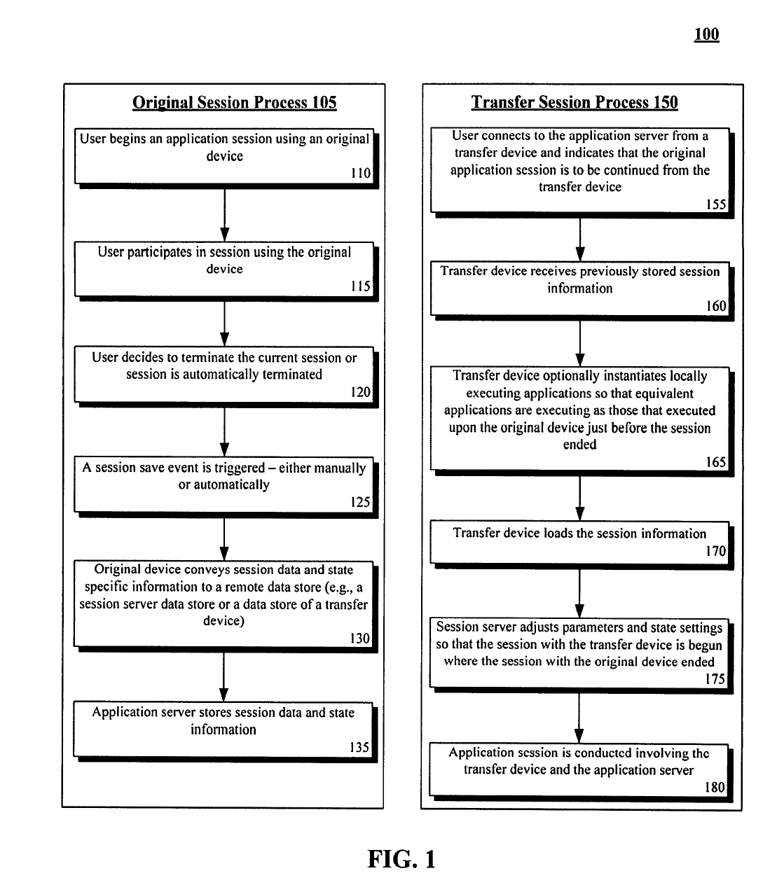

FIG. 1 is a flow chart of a method 100 for continuing a previous application session from a device other than an original device used during the application session. The method 100 shows two distinct processes, one being an original session process 105 and the other the transfer session process 150. In one embodiment, the processes 105 and 150 can occur after a time delay, which means that the original session is terminated an appreciable time before the continuing session begins. In another embodiment, the processes 105 and 150 can occur at approximately adjacent times. Further, an ongoing session endpoint can be switched from the original device to a transfer device in a manner transparent to other communicators involved in the application session. Although the method 100 indicates that the original session process 105 is conducted from an original device and that the transfer session process 150 is conducted from a transfer device 150, in a contemplated derivative implementation, the same device can be used for both processes 105, 150.

The original session process 105 can begin in step 110, when a user begins an application session involving an application server and an original client-side device. In step 115, the user can conduct actions within the session. In step 120, the user can decide to terminate the current session or the session can be terminated automatically. Either type of termination can trigger a session save event, in which current information related to the session is preserved, as shown by step 125. In step 130, the original device can convey device specific session data and state information to a remote data store. This remote data store can be a data store of the application server, a data store of a transfer device, or any other remotely located data store accessible by either the application server or the transfer device. In step 135, the application server can store session data and state information.

In one embodiment, the application server can time stamp session data and temporally order the stamped data. For example, once the session save event (step 125) is triggered, all subsequent session data can be time stamped, assuming that the application server does not automatically time stamp all session data during normal operations. Time stamping and/or temporally ordering session data can be essential for restoring the session once the transfer process 150 has completed, especially for interactive applications (e.g., IM application) where temporal and causal ordering of session user data and session events can be particularly important.

Transfer session process 150 can begin in step 155, where a user connects to the application server from a transfer device. During this connection, the connecting device can indicate that the original application session is to be continued from the transfer device. In step 160, the transfer device can receive previously stored information. This transfer can occur from a data store where the original device stored information during step 130. In step 165, the transfer device can optionally instantiate locally executing applications. This ensures that the transfer device is executing approximately equivalent applications as those executed by the original device when the original session ended. The applications of concern can be limited to those directly involved in the session. In step 170, the transfer device can load session information into a local data store and/or the executing applications. In step 175, the session server can adjust parameters and state settings so that a session with the transfer device begins where the session with the original device ended. In step 180, the application session can be conducted.

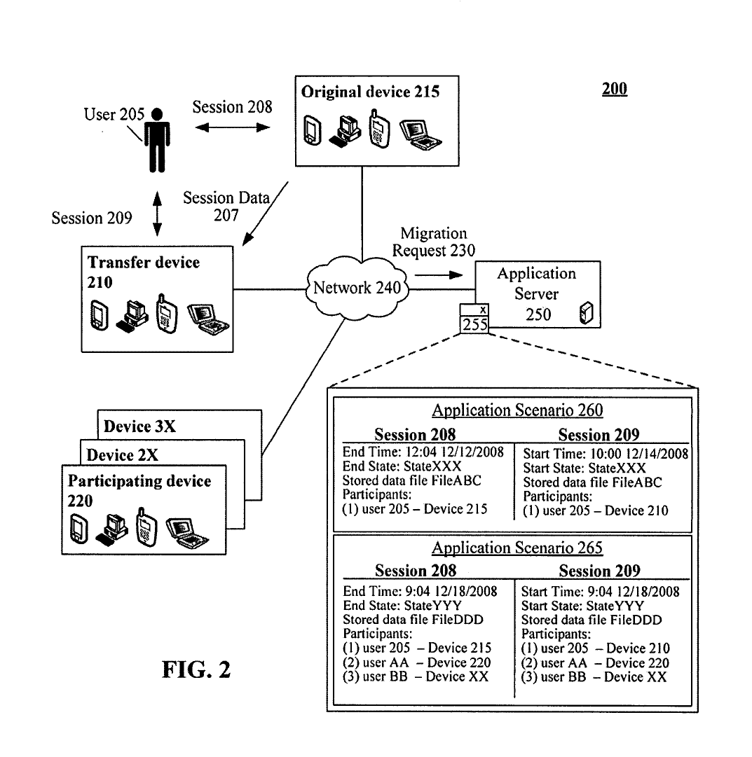

FIG. 2 is a schematic diagram of a system 200 that is capable of continuing previous application sessions in a state at which the session ended. The system 200 can be a system in which method 100 is performed.

In system 200, user 205 can use original device 215 to establish an application session 208 with an application server 250 over network 240. An application 255 can handle server-side interactions for the application session. During the application session, a migration request 230 can be sent to the application server 250, which indicates that the session is to be migrated or transferred to transfer device 210. In other words, the session 208 being conducted by device 215 is to be hatted and continued upon transfer device 210. Session data 207 can be transferred to the transfer device 210 so that information necessary to continue the halted session is available to the transfer device 210. The application server 250 can also cache session information so that it is able to continue the session 209 involving the transfer device 210 from a point at which the session 208 ended.

The continuation of the session 208 can occur after a delay period or can occur in an immediate fashion. Additionally, the session migration request 230 can be initiated from the transfer device 210 or from the original device 215 by user 205 or the migration request can be automatically initiated based upon a detectable event, such as session 208 terminating unexpectedly. Further, the sessions 208 and 209 can be sessions involving only the user 205 and the application server 250 or can involve one or more additional participating devices 220.

Two illustrative scenarios 260, 265 are expressed in system 200. The first scenario 260 shows application server 250 internal information for an interaction involving only user 205 and application server 250, which is continued after a delay period. The second scenario 265 relates to a communication session involving multiple participants, where user 205 migrates from device 215 to device 210 in a manner transparent to other participants of the communication session.

In scenario 260, the application server 250 can record an end time (e.g., 12:04 12/12/2008), an end state (e.g., StateXXX), and a stored data file (e.g., FileABC) relating to session 208. The session 208 participants can be stored as well, which in scenario 260 includes user 205 using device 215. Session 209 of scenario 260 can represent resume state values for session 209. These values can include a start time (e.g., 10:00 12/14/2008), a start state (e.g., StateXXX), a stored data file (e.g., FileABC), and a participant listing (e.g., user 205 from device 210). Session data 207 for scenario 260 can be transferred to device 210 from device 215 or from the server 250.

In scenario 265, the application server 250 can record for session 208 a session end time (e.g., 9:04 12/18/2008), an end state (e.g., StateYYY), a stored data file (e.g., FileDDD), and a participant listing (e.g., user 205 from device 215; user AA from device 220; user BB from device XX). Session 209 of scenario 260 can represent resume state values for session 209. These values can include a start time (e.g., 9:04 12/18/2008), a start state (e.g., StateYYY), a stored data file (e.g., FileDDD), and a participant listing (e.g., user 205 from device 210; user AA from device 220; user BB from device XX).

As used in system 200, the application session 208, 209 can be any type of session able to be conducted over network 240. For example, the application session 208, 209 can be an a web browsing session, a served application session, an email session, a text exchange session, a media streaming session, an interactive gaming session, a real-time voice communication session, and the like.

The migration request 230 can be a digitally encoded message able to be conveyed over network 240. The request 230 can include transfer details, such as device 215 and 210 identifiers, state information, authorization codes, and the like. Security measures can be taken to ensure that only an authorized transfer device 210 is able to resume session 208.

Each of the devices 210, 215, and 220 can be any computing device able to participate in an application session 208, 209 with the application server 250. For example, each of the devices 210, 215, and 220 can be implemented as a personal computer, a mobile phone, an embedded computing device, a portable computing device, an in-vehicle computing device, an electronic gaming device, and the like.

Network 240 can include a set of components that are capable of conveying digital content encoded within carrier waves. Conveyed content can be contained within analog or digital signals, can be conveyed through data or voice channels, and can be conveyed over a personal area network (PAN) or a wide area network (WAN). The network 240 can include local components and data pathways necessary for communications to be exchanged among computing device components and between integrated device components and peripheral devices. The network 240 can also include network equipment, such as routers, data lines, hubs, and intermediary servers which together form a packet-based network, such as the Internet or an intranet. The network. 240 can further include circuit-based communication components and mobile communication components, such as telephony switches, modems, cellular communication towers, and the like. The network 240 can include line based and/or wireless communication pathways.

Each of the devices 210, 215, 220, 250 can store information in a local data store, or a networked data store to which the device 210, 215, 220, 250 is granted access. Each of these data stores can be physically implemented within any type of hardware including, but not limited to, a magnetic disk, an optical disk, a semiconductor memory, a digitally encoded plastic memory, or any other recording medium. Each of the data stores can be a stand-alone storage unit as well as a storage unit formed from a plurality of physical devices which may be remotely located from one another. Additionally, information can be stored within the data stores in a variety of manners. For example, information can be stored within a database structure or can be stored within one or more files of a file storage system where each file may or may not be indexed for information searching purposes. Information stored in the data stores can also be optionally encrypted for added security.

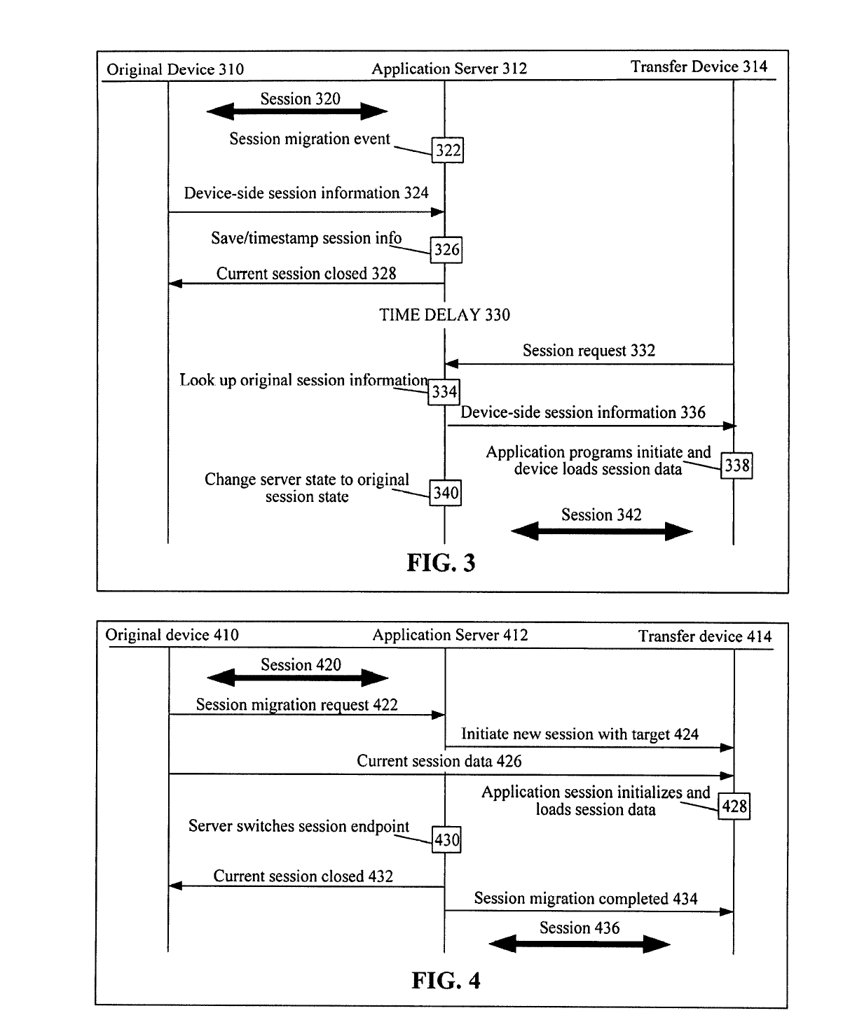

FIG. 3 is flow diagram showing a continuation of an application session on a device other than an original device. This flow diagram can occur in the context of system 200. The message flows of FIG. 3 can be conveyed between an original device 310, an application server 312, and a transfer device 314.

Initially, a session 320 can be conducted between original device 310 and application server 312. During the session, a session migration event 322 can be detected. The event 322 can result from a user submitting a session migration request from either the original device 310 or the transfer device 314. The original device can convey device-side session information 324 to the application server. The application server 312 can save and timestamp session information, which includes in this situation both server-side and client-side information. The session can then be closed 328 between the application server 312 and the original device 310.

In a different configuration, device-side session information 324 can be conveyed directly from the original device 310 to transfer device 314. For example, the device scan be in proximity to each other and connected with a communication pathway (e.g., BLUETOOTH, USB, and the like) over which session information can be conveyed. Direct device-to-device transfer of information alleviates a need for the server 312 to maintain device-side session data, but it is not feasible in all situations. For instance, device-to-device transfers may not be feasible when the devices 310, 314 are not communicatively linked or when the devices 310, 314 are unable to address each other at a time at which the session migration event 322 occurs.

After an arbitrary time delay 330, a session request 332 can be submitted to the server 312 from the transfer device 314. The request 332 can indicate that the device 314 is to initiate a session in a state at which the original device 310 ended. The server 312 can look up original session information 334 and can convey device side session information 336 to the transfer device 314. The transfer device can initiate 338 local programs and load session data. The server 312 can adjust 340 settings and parameters to those that permit the server 312 to begin the session 342 with device 314 in approximately the same state as when the session with device 310 ended.

FIG. 4 is flow diagram showing a migration of an application session from one device to another without terminating the session. That is, the session is effectively continued without any substantial delay even though the session has been transferred from an original device to a transfer device 414. When additional participants are involved in the session served by server 412, the transfer between devices 410, 414 can be transparent to these additional participants. This flow diagram can occur in the context of system 200.

An original session 420 can be conducted between device 410 and the application server 412. A session migration request 422 can be submitted from device 410 to server 412. The server 412 can then initiate 424 a new session with a transfer device 414 specified within the request 422. Current session data 426 can be conveyed from the original device 410 to the transfer device 414. The transfer device 414 can initiate local applications equivalent to those executing on device 410 for the session 420, as needed. The session data 426 can be loaded into the initiated applications. The server 412 can then switch 430 communication endpoints from the original device 410 to the transfer device 414. The session with the original device 410 can be closed 432. The session migration operation can be completed 434, where communications continue in a session 436 involving server 412 and device 414.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for migrating an application session comprising:
identifying an application session comprising an application server and an original device;
during the application session, detecting a migration event;
responsive to the migration event, storing client-side session information and server-side information pertaining to the application session;
conveying the client-side session information to a transfer device;
establishing a communication connection between the transfer device and the application server;
changing transfer device settings in accordance with the client-side session information;
adjusting application server parameters in accordance with the stored server-side information; and
conducting an application session involving the transfer device and the application server that begins in a state approximately equivalent to a state in which the identified application session involving the original device ended.

2. The method of claim 1, where a substantial delay period exists between the application session involving the original device ends and the application session involving the transfer device begins.

3. The method of claim 1, wherein the application session involving the original device and the application session involving the transfer device also involve at least one participant device used by an entity that communicates in real-time with an entity that is utilizing the original device and the transfer device, wherein the steps of claim 1 are performed in a manner transparent to the at least one participant device.

4. The method of claim 1, wherein the original device and the transfer device each execute a client-side application used for interacting during the application session, said method further comprising:
the client-side application of the transfer device loading client-side session information before the conducting step.

5. The method of claim 1, further comprising:
The application server time stamping application session information received after the migration event was detected, wherein the information from the time stamping is used to ensure the application session involving the transfer device begins in the state approximately equivalent to a state in which the identified application session involving the original device ended.

6. The method of claim 1, wherein the application session is at least one of a Web browsing session, an email session, and a voice communication session.

7. The method of claim 1, wherein the client-side session information is conveyed directly from the original device to the transfer device.

8. The method of claim 1, wherein the client-side session information is conveyed from the original device to the application server, and is conveyed form the application server to the transfer device.

9. The method of claim 1, further comprising:
detecting a user selection within an interface of the original device, which causes a migration request to be conveyed from the original device to the application server, wherein receipt of the migration request triggers the migration event.

10. The method of claim 1, further comprising:
detecting a user selection within an interface of the transfer device, which causes a migration request to be conveyed from the transfer device to the application server, wherein receipt of the migration request triggers the migration event.

11. The method of claim 1, wherein said steps of claim 1 are steps performed automatically by at least one machine in accordance with at least one computer program having a plurality of code sections that are executable by the at least one machine, said at least one computer program being stored in a machine readable medium.

12. A communication device comprising:
a client-side application for conducting an application session comprising an application server; and
a transceiver for connecting the communication device to a network, wherein the network communicatively links the communication device to the application server, wherein the client-side application is able to begin an application session with the server in a state in which an application session between an original device and the application server ended.

13. The communication device of claim 12, wherein the communication device is a mobile communication device, and wherein the transceiver is a wireless transceiver.

14. The communication device of claim 12, where a substantial delay period exists between the application session involving the original device ends and the application session involving the communication device begins.

15. The communication device of claim 12, wherein the original device is a personal computer, and wherein the communication device is a mobile telephone.

16. The communication device of claim 12, wherein the application session involving the original device and the application session involving the communication device also involve at least one participant device used by an entity that communicates in real-time with an entity that is utilizing the original device and the communication device, wherein a transfer between the original device and the communication device occurs without a substantial delay period and occurs in a manner transparent to the at least one participant device.

17. The communication device of claim 12, wherein the original device comprises an original client-side application configured to interact with the application server; said communication device further comprising:
a transfer client-side application configured to interact with the application server, wherein the transfer client-side application is initiated in approximately a same start state as that of the original client-side application when the application session between the original device and the application server ended.

18. An application server configured to execute at least one application during an application session involving a remotely located original device, said application server comprising:
a migration engine configured to handle migration requests, wherein a migration request is a user initiated request to end the application session involving the original device and configured to after an arbitrary delay initiate a transfer session handled by the application server, said transfer session involving a transfer device, wherein the transfer session begins in a state at which the application session involving the original device ends.

19. The application server of claim 18, further comprising:
a data store accessible by the application server configured to store server-side session information related to the application session, wherein said stored server-side session information is used when initiating the transfer session, wherein at least a portion of the server-side session information is time stamped.

20. The application server of claim 18, further comprising:
a data store accessible by the application server configured to store client-side session information conveyed from the original device, wherein the client-side information is conveyed from the application server to the transfer device when the transfer session is initiated.
